(19) United States
(12) Patent Application Publication
(10) Pub. No.: US 2021/0383245 A1
(43) Pub. Date: Dec. 9, 2021

(54) DEVICE AND METHOD FOR PLANNING AN OPERATION OF A TECHNICAL SYSTEM

(71) Applicant: Robert Bosch GmbH, Stuttgart (DE)

(72) Inventors: Jonathan Spitz, Leonberg (DE); Andre Biedenkapp, Freiburg Im Breisgau (DE); David Speck, Freiburg Im Breisgau (DE); Frank Hutter, Freiburg Im Breisgau (DE); Marius Lindauer, Lehrte (DE); Robert Mattmueller, Freiburg Im Breisgau (DE)

(21) Appl. No.: 17/242,790

(22) Filed: Apr. 28, 2021

(30) Foreign Application Priority Data
Jun. 5, 2020 (EP) 20178576.3

(51) Int. Cl. G06N 5/00; G06K 9/62; G05B 19/045; G05B 19/05

(52) U.S. Cl. CPC G06N 5/003; G06K 9/6263; G05B 2219/13009; G05B 19/056; G05B 19/045

(57) ABSTRACT

A computer-implemented method for planning an operation of a technical system within its environment. The method includes: obtaining state information comprising: a current domain, a time step and a current state; determining by heuristics costs for reachable states from the current state; selecting a heuristics by a policy out of a set of predefined heuristics depending on the state information and costs; choosing the state with the lowest cost returned by the selected heuristic from the reachable states, and determining an operation of the technical system out of the set of possible operation that has to be carried out by the technical system to reach said state with the lowest costreturned by the selected heuristic.

### CROSS REFERENCE

The present application claims the benefit under 35 U.S.C. § 119 of European Patent Application No. EP 20178576.3 filed on Jun. 5, 2020, which is expressly incorporated herein by reference in its entirety.

### FIELD

The present invention relates to a method for planning an operation of a technical system within its environment, a computer program and a machine-readable storage medium.

### BACKGROUND INFORMATION

Heuristics are an approach to problem solving that are derived from previous experiences in similar problems. A heuristic technique is generally not guaranteed to be optimal but is sufficient for reaching an immediate goal. Such techniques are commonly used in computer science to quickly finding an approximate solution to a problem when classical methods are slow or unable to find any exact solution, e.g. to find a path of a robot to the immediate goal. For example, heuristics are commonly used to improve the convergence of search algorithms, such as A* search, by deciding which possibilities to explore first.

Heuristic forward search is one of the most popular and successful techniques in classical planning. Although there is a large number of heuristics, the performance, i.e., the informativeness, of a heuristic varies from domain to domain. While in optimal planning it is easy to combine multiple admissible heuristic estimates, e.g., using the maximum, in satisficing planning the estimates of inadmissible heuristics are difficult to combine in a reasonable way. The reason for this is that highly inaccurate and uninformative estimates of a heuristic can have a negative effect on the entire search process when aggregating all estimates.

### SUMMARY

Since the performance of a heuristic varies from domain to domain, alternating between multiple heuristics during the search makes it possible to use all heuristics equally and improve performance.

However, this approach ignores the internal search dynamics of a planning system, which can help to select the most helpful heuristics for the current expansion step.

In accordance with the present invention, a policy is utilized, preferably trained via Dynamic Algorithm Configuration (DAC), for dynamic heuristic selection which takes into account the internal search dynamics of a planning system. This may have the advantage that it generalizes over existing approaches and can exponentially improve the performance of the heuristic search and exceed existing approaches in terms of coverage. Hence, the present invention finds more quickly a solution than classical methods, and the solution is very close to the optimal solution.

DAC utilizes reinforcement learning to learn policies for online adjustments of algorithm parameters in a data-driven way by formulating the dynamic algorithm configuration as a contextual Markov decision process, such that reinforcement learning not only learns a policy for a single instance, but across a set of instances. DAC is described in detail here: https://ml.informatik.uni-freiburg.de/papers/20-ECAI-DAC.pdf.

In a first aspect of the present invention, a computer-implemented method for planning an operation of a technical system within its environment is provided. The environment is characterized by a current domain out of a set of different domains, a current state out of a set of states of the respective domains and a set of possible operations, which can be carried out by the technical system within each domain. In accordance with an example embodiment of the present invention, the method includes the following steps:
i) Obtaining state information comprising: the current domain, the time step and the current state of the environment.
ii) Determining by each heuristic out of a set of predefined heuristics costs for a plurality of reachable states from the current state;
iii) Selecting a heuristic out of the set of predefined heuristics by a policy depending on the state information and in particular the determined costs. The heuristics are configured to estimate costs to reach a goal state from a given state, and the policy has been trained to select heuristics in such a way that the technical systems carries out the operations with minimal search effort at plan time to reach the goal state;
iv) Choosing the state with the lowest cost determined by the selected heuristic by the policy from the reachable states; and
v) Determining an operation of the technical system out of the set of possible operation that has to be carried out by the technical system to reach said state with the lowest cost.

In accordance with an example embodiment of the present invention, it is provided that after the step of determining the operation of the technical system by choosing the operation with the lowest value returned by the selected heuristic depending on a current state, a control signal configured to control the technical system to carry out the next operation can be determined. Furthermore, in a subsequent step, the technical system can be controlled depending on the determined operation or depending on the determined control signal.

An advantage of the method is that the policy, in particular with its special input: state information and in particular the costs, is able to guide the technical system more efficient towards the goal state. For example if the technical systems heads forward to an obstacle, typically due to standard heuristic planning, the technical system needs some trails in order to find a way around the obstacle. Because of the policy, a heuristic is chosen that minimizes the overall number of required states to reach the goal state, the policy would select a heuristic which can prevent to trying out to find a way around via a flexible choose of the heuristic out of the set of heuristics with the expected minimal number of expanded states to reach the goal state.

Another advantage is that the planning procedure can be used for a variety of different environments and is therefore flexible. The planner can switch between domains. Furthermore, due to the policy an optimal heuristic can be found for different progresses of the technical system towards reaching its goal state, e.g. during beginning a course heuristic is more efficient, wherein in the proximity of the goal state, a finer heuristic is more efficient. Therefore, the planning method is very powerful and flexible.

Under domains it can be understood a structure and/or a classification of the environment of the technical system, e.g., indoor/outdoor or city/highway, etc. Also conditions of the environment of the technical system can be understood under domain, e.g. weather conditions (rainy, sunny, snowy, . . . ) or light conditions, etc.

The current state can also extended and comprises features characterizing the internal state of the technical system.

It is noted that the present method can directly applied to a setting comprising a plurality of goal states.

Preferably, the state information can also include previously determined costs of previous states and the policy also chooses the heuristic depending on previous determined costs.

Preferably, the policy can be configured or trained to select the most informative heuristic at each step of the planning procedure. Costs have to be spend for carrying out the operations of the technical system. The total costs refers to the sum of the necessary costs to reach the goal state. For example, costs can corresponds to energy and/or time.

Reachable states are these states which can be immediately reached by the technical system by carrying out at least one operation from the current state.

Additionally or alternatively, the policy can be trained in such a way that the technical system requires a minimal number of operations to accomplish the goal state.

Furthermore, in accordance with an example embodiment of the present invention, it is provided that the current state for each domain out of the plurality of domains is characterized by at least the following features: maximum cost that can be returned by each heuristic of the set of predefined heuristics, minimum cost that can be returned by each heuristic of the set of predefined heuristics, average costs returned from each heuristic of the set of predefined heuristics, variance of the costs returned from each heuristic of the set of predefined heuristics, number of states maintained by each heuristic of the set of predefined heuristics, and the current time step.

The time step is a time step of a sequence of time steps starting from the first state of the technical system, wherein each time step is assigned to a state of the technical system.

Advantageously, the state features, that inform the policy about the characteristics and preferably about the behavior of the planning procedure, are domain independent, such that the same features can be used for a wide variety of domains. In addition, such state features should be cheap to compute in order to keep the overhead as low as possible making them applicable for time critical systems or situations.

Furthermore, in accordance with an example embodiment of the present invention, it is provided that the state further comprises a feature reflecting context information of the current domain. It is possible to reflect an domain with state features that describe, for example, the variables, operators or the causal graph, e.g. as described by Sievers, S.; Katz, M.; Sohrabi, S.; Samulowitz, H.; and Ferber, P. 2019. “Deep learning for cost-optimal planning: Task dependent planner selection.” This may have the advantage that the policy can better adjusted to the different domains and is able to make more precise decisions.

If the goal is to learn robust policies that can handle highly heterogeneous sets of domains, it is possible to add contextual information about the planning domain at hand, such as the problem size or the required preprocessing steps, as exemplarily shown by Fawcett, C.; Vallati, M.; Hutter, F.; Hoffmann, J.; Hoos, H.; and Leyton-Brown, K. 2014. “Improved features for runtime prediction of domain-independent planners.” In Proc. ICAPS 2014.

Furthermore, in accordance with an example embodiment of the present invention, it is provided that the steps i) to iv) are subsequently carried out several times until the current state corresponds to the goal state, wherein the chosen states with the lowest costs are stored in a list, wherein depending on the list, a sequence of operations is determined which generates a sequence of states of the list to reach the goal state. Optionally, the heuristics are determined for all previously expanded states stored in the lists.

This procedure, namely a state with the minimal cost is expanded and its subsequent state is added to the list, can be referred to as heuristic search.

Additionally or alternatively, the policy can be trained in such a way that the heuristic search minimizes the number of state expansions.

Utilizing the policy for heuristic search has the advantage to improve the search performance exponentially, since it helps to reduce the search effort and thus improves the performance of a planner. Because the policy selects the heuristic with the expected lowest planning time, which increases then exponentially, only one heuristic selected by the policy is sufficient to expand the search space to find a path to the goal state. Therefore, less states are stored in the list improving exponentially the performance.

If more than one goal state is defined, it is sufficient to carry out the steps i) to iv) until at least one goal state is accomplished.

Furthermore, in accordance with an example embodiment of the present invention, it is provided that depending on the sequence of operations, the technical system is controlled or a trajectory is determined for controlling the technical system.

Furthermore, in accordance with an example embodiment of the present invention, it is provided that for each heuristic, a list is used and the most promising state of each list is with the corresponding list expanded, wherein a successor state is added to all lists and evaluated with the corresponding heuristics of the respective lists.

This may have the advantage that a search progress is shared between the heuristics resulting in a more efficient search procedure.

Furthermore, in accordance with an example embodiment of the present invention, it is provided that the set of heuristics comprise at least one of the following heuristics: fast-forward planning heuristic or causal graph heuristic or context-enhanced additive heuristic or an additive heuristic.

The heuristics are described by the following papers: Hoffmann, J., and Nebel, B. 2001. “The FF planning system: Fast plan generation through heuristic search.” JAIR 14:253-302; and Helmert, M. 2004. “A planning heuristic based on causal graph analysis.” In Proc. ICAPS 2004, 161-170; and Helmert, M., and Geffner, H. 2008. “Unifying the causal graph and additive heuristics.” In Proc. ICAPS 2008, 140-147; and Bonet, B., and Geffner, H. 2001. “Planning as heuristic search.” AIJ 129(1):5-33.

Furthermore, in accordance with an example embodiment of the present invention it is provided that the policy is trained via reinforcement learning.

An advantage of reinforcement learning is that simulation have shown that the trained policy can nearly recover the optimal policy.

During reinforcement learning, the policy receives the state information, and in particular costs of all heuristics, and learns therefrom which heuristic out of the set of heuristics is potentially the best one for a given domain and state.

Furthermore, in accordance with an example embodiment of the present invention, it is provided that the policy is trained by Dynamic Algorithm Control (DAC).

Furthermore, in accordance with an example embodiment of the present invention, it is provided that a sparse reward function is utilized. A sparse reward function ignores aspects such as the quality of a plan, but its purpose is to reduce the search effort and thus improve search performance.

Example embodiments of the present invention are discussed below with reference to the figures in more detail.

### BRIEF DESCRIPTION OF THE DRAWINGS

FIG. 1 shows a control system having a classifier controlling an actuator in its environment, in accordance with an example embodiment of the present invention.

FIG. 2 shows the control system controlling an at least partially autonomous robot, in accordance with an example embodiment of the present invention.

FIG. 3 shows the control system controlling a manufacturing machine, in accordance with an example embodiment of the present invention.

FIG. 4 shows the control system controlling an imaging system, in accordance with an example embodiment of the present invention.

### DETAILED DESCRIPTION OF EXAMPLE EMBODIMENTS

The general idea of planning algorithms with a single heuristic h is to start with the initial state and to expand the most promising states based on the heuristic h until a goal state is found. During the search, relevant states are stored in an open list that is sorted in ascending order by the values returned by the heuristic depending on the respective states so that the state with the lowest heuristic values, i.e. the most promising state, is at the top. More precisely, in each step a state s with minimal heuristic value is expanded, i.e. its successors are generated and states not already expanded are added to the open list according to their heuristic values h(s). Within an open list, for states with the same heuristic value (h-value) the tie-breaking rule can be used according to the first-in-first-out principle.

In satisficing planning, it is possible to combine multiple heuristic values for the same state in arbitrary ways. It has been shown, however, that the combination of several heuristic values into one, e.g. by taking the maximum or a (weighted) sum, does not lead to informative heuristic estimates. This can be explained by the fact that if one or more heuristics provide very inaccurate values, the whole expansion process is affected. It was proposed to maintain multiple heuristics H=h₀, . . . , hₙ₋₁ within one greedy best-first search. More precisely, it is possible to maintain a separate open list for each heuristic h ∈ H and switch between them at each expansion step while always expanding the most promising state of the currently selected open list. The generated successor states are then added to all open lists and evaluated with the corresponding heuristic function. This makes it possible to share the search progress. In particular, a predetermined alternated selection, in which all heuristics are selected one after the other in a cycle such that all heuristics are treated and used equally, has proven to be an efficient method. Such equal use of heuristics can help to progress the search space towards a goal state, even if only one heuristic is informative. However, in some cases it is possible to infer that some heuristics are currently, i.e. in the current search space, more informative than others, which is ignored by the alternating selection. Because of the alternation selection, the choice of the heuristic depends only on the current time step and not on the current search dynamics or planner state.

It is possible to maintain a set of heuristics H each associated with a separate open list in order to allow the alternation between such heuristics.

Considering H as an configuration space ϕ of a heuristic search algorithm A and each state expansion as a time step t, it is possible to classify different dynamic heuristic selection strategies within the framework of algorithm configuration.

For example, alternation is an adaptive control policy because it maps each time step to a specific heuristic, i.e. configuration, independent of the domain or the state of the planner. The selection of a particular heuristic depending on the current domain before solving the domain, is an algorithm selection policy that depends only on the domain and not on the current time step or the internal state of the planner.

The inventors found that all three components—the domain, the time step, and the state of the planner—can be important and helpful in selecting the heuristic for the next state expansion.

Therefore, in accordance with an example embodiment of the present invention, a dynamic algorithm configuration policy π trained via reinforcement learning is used in order to reduce the search effort and thus improving the performance of a planner.

In a preferred embodiment, Dynamic Algorithm Configuration (DAC) for learning the policy π is proposed.

DAC is a recent meta algorithmic framework that makes it possible to learn to adjust the hyperparameters of an algorithm given a description of the algorithm's behavior.

DAC operates as follows: Given a parameterized algorithm A with its configuration space ϕ, a set of problem domains I the algorithm has to solve, a state description s of the algorithm A solving an domain i ∈ I at time step t ∈ N₀, and a reward signal r assessing the reward of using policy π to control A on an domain i ∈ I. The goal is to find policy π that adapts a configuration ϕ ∈ Φ given a state s of A at time t optimizing its reward across a set of domains. Note that the current time step t and domain i ∈ I can be encoded in the state description of an algorithm A.

At each time step t, the planner sends the current internal state s˜ and the corresponding reward r to the policy π based on which the controller decides which heuristic h ∈ H to use. The planner progresses according to the decision to the next internal state with its reward.

For the reward function of DAC, a reward of −1 is proposed for each expansion step that the planning system has to perform in order to find a solution. Using this reward function, a configuration policy learns to select heuristics that minimize the expected number of state expansions until a solution is found. This reward function can be referred to as a sparse reward function and ignores aspects such as the quality of a plan, but its purpose is to reduce the search effort and thus improve search performance. Clearly, it possible to define other reward functions with, e.g., dense rewards to make the learning easier.

The policy learns which heuristic will be the most informative at each step of the solution search. It is learned through trial and error with RL in simulations. All heuristics can be run in parallel and the list of the heuristics are updated then. Preferably, the RL policy receives features on the values of all heuristics as a state.

Preferably, the policy π is a neural network. Simulation have shown that a 2-layer network with roughly 75 hidden units and a linear decay for ε over 5×10\hat{ }5 steps from 1 to 0:1 worked best and it was possible to learn policies with a performance close to the optimal policy.

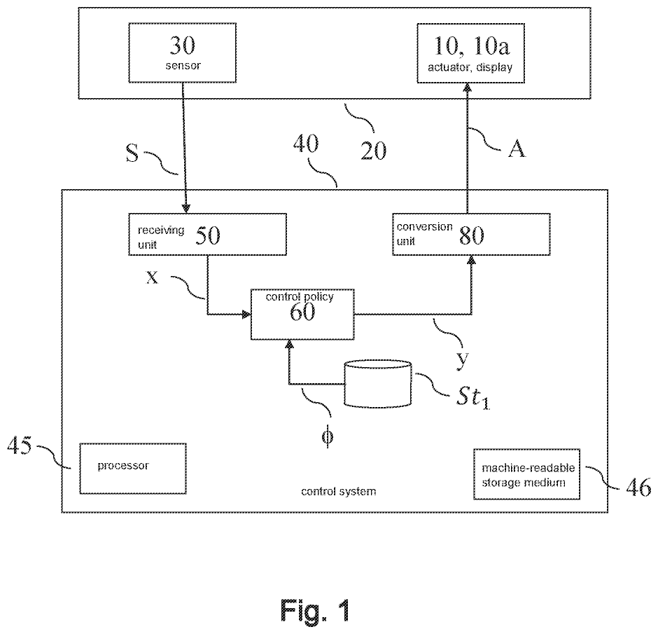

Shown in FIG. 1 is one embodiment of an actuator 10 in its environment 20. Actuator 10 interacts with a control system 40. Actuator 10 and its environment 20 will be jointly called actuator system. At preferably evenly spaced distances, a sensor 30 senses a condition of the actuator system. The sensor 30 may comprise several sensors. Preferably, sensor 30 is an optical sensor that takes images of the environment 20. An output signal S of sensor 30 (or, in case the sensor 30 comprises a plurality of sensors, an output signal S for each of the sensors) which encodes the sensed condition is transmitted to the control system 40.

Thereby, control system 40 receives a stream of sensor signals S. It then computes a series of actuator control commands A depending on the stream of sensor signals S, which are then transmitted to actuator 10.

Control system 40 receives the stream of sensor signals S of sensor 30 in an optional receiving unit 50. Receiving unit 50 transforms the sensor signals S into input signals x describing the state s. Alternatively, in case of no receiving unit 50, each sensor signal S may directly be taken as an input signal x

Input signal x is then passed on to the control policy 60, which may, for example, be given by an artificial neural network.

Control policy 60 is parametrized by parameters ϕ, which are stored in and provided by parameter storage St₁.

Control policy 60 determines the selection of the heuristic out of the set of heuristics H depending on the input signals x. The heuristic comprises information that assigns one or more labels to the input signal x. The heuristic is transmitted to a processor 45, which determines the next state for which the heuristic y returns the lowest costs. A corresponding operation, which has to be carried out by an actor to reach the next state is determined by the processor 45. The corresponding operation is referred to as output signal y. An optional conversion unit 80, which converts the output signals y into the control commands A. Actuator control commands A are then transmitted to actuator 10 for controlling actuator 10 accordingly. Alternatively, output signals y may directly be taken as control commands A.

Actuator 10 receives actuator control commands A, is controlled accordingly and carries out an action corresponding to actuator control commands A. Actuator 10 may comprise a control logic which transforms actuator control command A into a further control command, which is then used to control actuator 10.

In further embodiments, control system 40 may comprise sensor 30. In even further embodiments, control system 40 alternatively or additionally may comprise actuator 10.

Furthermore, control system 40 may comprise a processor 45 (or a plurality of processors) and at least one machine-readable storage medium 46 on which instructions are stored which, if carried out, cause control system 40 to carry out a method according to one aspect of the present invention.

Preferably, the present invention can be used to improve the performance of a problem solving algorithm where a set of heuristics are available. Particularly, the present invention can help a search algorithm find a solution more quickly by selecting the best heuristic to use in each step. For example, such search algorithms can be applied to find an optimal path for a mobile robot in a path planning problem or an optimal distribution of jobs to available transportation robots or production machines in a scheduling problem.

In the scheduling case, a set of jobs J with various durations needs to be distributed between a set of machines M with various properties. E.g. in the semiconductor industry, different machines are used for different parts of the production process: etching, deposition, photo-lithography, etc. Some machines can complete batches of jobs at once, while other can only take care of one job at a time. Scheduling all jobs such that they are all completed in the shortest time possible is a computationally hard problem which is usually solved with numerical solvers.

To make the search more efficient, many different heuristics (or dispatching rules) can be used, for example:
First-In-First-Out (FIFO) will schedule first the job that arrived first,
Earliest Due Date (EDD) will prioritize the job with the earliest due date, i.e. the one that the customer is expecting at the earliest,
Shortest Processing Time (SPT) will schedule the job with the shortest processing time first. Using this heuristic leads to a short cycle time,
Highest Value First (HVO) will schedule the job of the highest value to the customer first,
Weighted SPT (WSPT) is a version of SPT that also takes into account the value of the job.

When combining these heuristics to search for the best solution, a search algorithm might fill in the first job in the job queue using WSPT, the second with EDD, the third with HVO and so forth. The policy has learned which is the best heuristic, i.e. which provides the most information, at each step of the scheduling process.

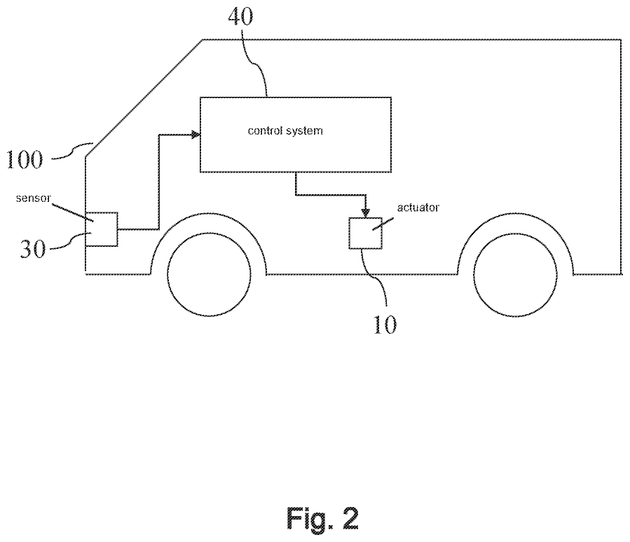

FIG. 2 shows an embodiment in which control system 40 is used to control an at least partially autonomous robot, e.g. an at least partially autonomous vehicle 100, in particular for the above mentioned scheduling case.

Sensor 30 may comprise one or more video sensors and/or one or more radar sensors and/or one or more ultrasonic sensors and/or one or more LiDAR sensors and or one or more position sensors (like e.g. GPS). Some or all of these sensors are preferably but not necessarily integrated in vehicle 100.

Alternatively or additionally sensor 30 may comprise an information system for determining a state of the actuator system. One example for such an information system is a weather information system which determines a present or future state of the weather in environment 20.

Actuator 10, which is preferably integrated in vehicle 100, may be given by a brake, a propulsion system, an engine, a drivetrain, or a steering of vehicle 100.

In further embodiments, the at least partially autonomous robot may be given by another mobile robot (not shown), which may, for example, move by flying, swimming, diving or stepping. The mobile robot may, inter alia, be an at least partially autonomous lawn mower, or an at least partially autonomous cleaning robot. In all of the above embodiments, actuator command control A may be determined such that propulsion unit and/or steering and/or brake of the mobile robot are controlled such that the mobile robot may avoid collisions with said identified objects.

In a further embodiment, the at least partially autonomous robot may be given by a gardening robot (not shown), which uses sensor 30, preferably an optical sensor, to determine a state of plants in the environment 20. Actuator 10 may be a nozzle for spraying chemicals. Depending on an identified species and/or an identified state of the plants, an actuator control command A may be determined to cause actuator 10 to spray the plants with a suitable quantity of suitable chemicals.

In even further embodiments, the at least partially autonomous robot may be given by a domestic appliance (not shown), like e.g. a washing machine, a stove, an oven, a microwave, or a dishwasher. Sensor 30, e.g. an optical sensor, may detect a state of an object which is to undergo processing by the household appliance. For example, in the case of the domestic appliance being a washing machine, sensor 30 may detect a state of the laundry inside the washing machine. Actuator control signal A may then be determined depending on a detected material of the laundry.

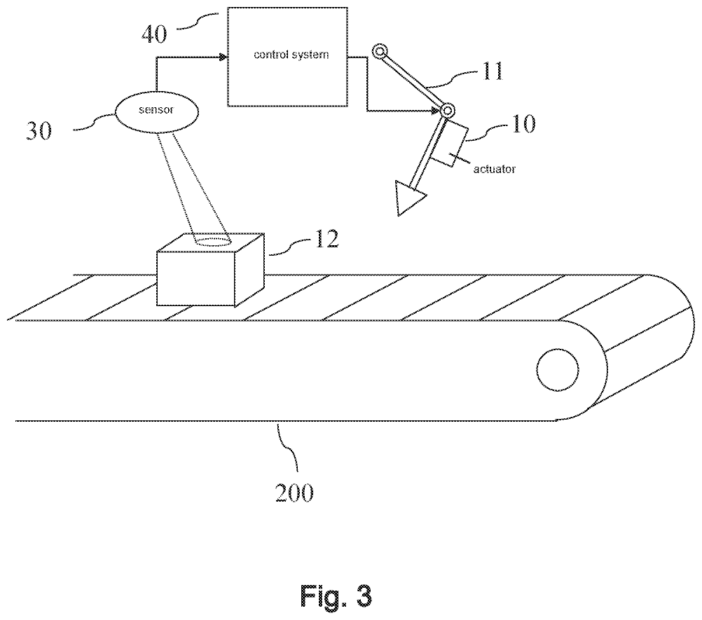

Shown in FIG. 3 is an embodiment in which control system 40 is used to control a manufacturing machine 11, e.g. a punch cutter, a cutter or a gun drill) of a manufacturing system 200, e.g. as part of a production line. The control system 40 controls an actuator 10 which in turn control the manufacturing machine 11.

Sensor 30 may be given by an optical sensor which captures properties of, e.g., a manufactured product 12. Control policy 60 may determine a state of the manufactured product 12 from these captured properties. Actuator 10 which controls manufacturing machine 11 may then be controlled depending on the determined state of the manufactured product 12 for a subsequent manufacturing step of manufactured product 12. Or, it may be envisioned that actuator 10 is controlled during manufacturing of a subsequent manufactured product 12 depending on the determined state of the manufactured product 12.

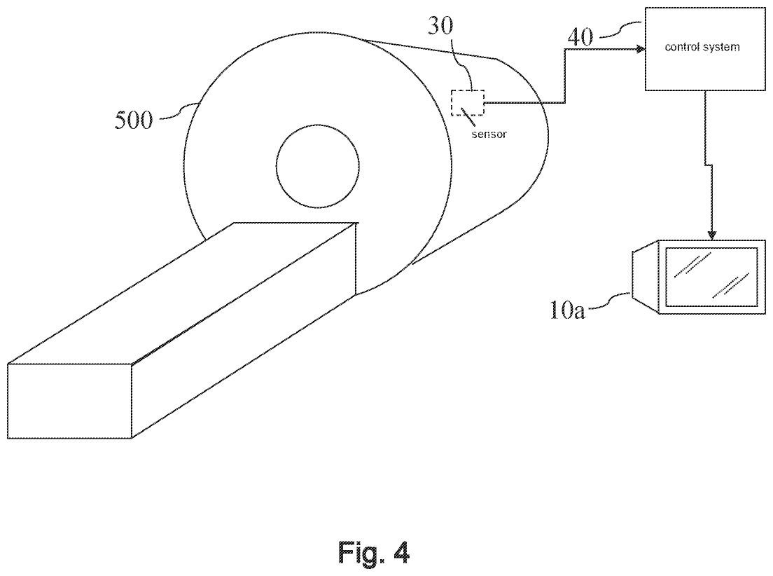

Shown in FIG. 4 is an embodiment of a control system 40 for controlling an imaging system 500, for example an MRI apparatus, x-ray imaging apparatus or ultrasonic imaging apparatus. Sensor 30 may, for example, be an imaging sensor. Machine learning system 60 may then determine a classification of all or part of the sensed image. Actuator control signal A may then be chosen in accordance with this classification, thereby controlling display 10a. For example, machine learning system 60 may interpret a region of the sensed image to be potentially anomalous. In this case, actuator control signal A may be determined to cause display 10a to display the imaging and highlighting the potentially anomalous region.

What is claimed is:

1. A computer-implemented method for planning an operation of a technical system within an environment of the technical system, the environment being characterized by a current domain out of a set of different respective domains, a current state out of a set of states of the respective domains, and a set of possible operations which can be carried out by the technical system, the method comprising the following steps:
i) obtaining state information including at least the current domain, a time step, and the current state of the environment;
ii) determining, by each heuristic out of a set of predefined heuristics, costs for a plurality of reachable states from the current state, wherein the heuristics are configured to estimate costs to reach a goal state from a given state;
iii) selecting a heuristic out of the set of predefined heuristics by a policy depending on the state information, wherein the policy has been trained to select the heuristic from the set of predefined heuristics, such that a minimal number of state expansions is expected when planning a path to the goal state;
iv) choosing a state with a lowest cost determined by the selected heuristic by the policy from the reachable states; and
v) determining an operation of the technical system out of the set of possible operation that has to be carried out by the technical system to reach the state with the lowest cost determined by the selected heuristic.

2. The method according to claim 1, wherein the current state for each domain out of the plurality of domains is characterized by at least the following features: maximum cost that can be returned by each heuristic of the set of predefined heuristics, minimum cost that can be returned by each heuristic of the set of predefined heuristics, average costs returned from each heuristic of the set of predefined heuristics, variance of costs returned from each heuristic of the set of predefined heuristics, number of states maintained by each heuristic of the set of predefined heuristics, and a current time step.

3. The method according to claim 2, wherein the state further includes a features reflecting context information of the current domain.

4. The method according to claim 1, wherein the steps i) to iv) are subsequently carried out several times until the current state corresponds to the goal state, wherein the chosen states with the lowest costs are stored in a list, wherein depending on the list, a sequence of operations is determined which generates a sequence of states of the list to reach the goal state.

5. The method according to claim 4, wherein, for each heuristic, a list is used and a most promising state with a lowest cost of the corresponding list of the selected heuristic by the policy is expanded.

6. The method according to claim 1, wherein the set of heuristics includes at least one of the following heuristics: fast-forward planning heuristic or causal graph heuristic or context-enhanced additive heuristic or an additive heuristic.

7. The method according to claim 1, wherein the policy is trained via reinforcement learning.

8. The method according to claim 7, wherein the policy is trained by Dynamic Algorithm Control (DAC).

9. The method according to claim 8, wherein a sparse reward function is utilized.

10. The method according to claim 1, wherein the technical system is a robot or a transportation system, wherein the operations corresponds to predefined movements of the robot or the transportation system.

11. A non-transitory machine-readable storage medium on which is stored a computer program for planning an operation of a technical system within an environment of the technical system, the environment being characterized by a current domain out of a set of different respective domains, a current state out of a set of states of the respective domains, and a set of possible operations which can be carried out by the technical system, the computer program, when executed by a computer, causing the computer to perform the following steps:
i) obtaining state information including at least the current domain, a time step, and the current state of the environment;
ii) determining, by each heuristic out of a set of predefined heuristics, costs for a plurality of reachable states from the current state, wherein the heuristics are configured to estimate costs to reach a goal state from a given state;
iii) selecting a heuristic out of the set of predefined heuristics by a policy depending on the state information, wherein the policy has been trained to select the heuristic from the set of predefined heuristics, such that a minimal number of state expansions is expected when planning a path to the goal state;
iv) choosing a state with a lowest cost determined by the selected heuristic by the policy from the reachable states; and
v) determining an operation of the technical system out of the set of possible operation that has to be carried out by the technical system to reach the state with the lowest cost determined by the selected heuristic.

12. A system for planning an operation of a technical system within an environment of the technical system, the environment being characterized by a current domain out of a set of different respective domains, a current state out of a set of states of the respective domains, and a set of possible operations which can be carried out by the technical system, the system configured to:
i) obtain state information including at least the current domain, a time step, and the current state of the environment;
ii) determine, by each heuristic out of a set of predefined heuristics, costs for a plurality of reachable states from the current state, wherein the heuristics are configured to estimate costs to reach a goal state from a given state;
iii) select a heuristic out of the set of predefined heuristics by a policy depending on the state information, wherein the policy has been trained to select the heuristic from the set of predefined heuristics, such that a minimal number of state expansions is expected when planning a path to the goal state;
iv) choose a state with a lowest cost determined by the selected heuristic by the policy from the reachable states; and
v) determine an operation of the technical system out of the set of possible operation that has to be carried out by the technical system to reach the state with the lowest cost determined by the selected heuristic.
